(19) United States
(12) Patent Application Publication
(10) Pub. No.: US 2008/0110720 A1
(43) Pub. Date: May 15, 2008

(54) Gravity Flow Track Using B-Deck Panel

(76) Inventors: Daniel W. Ross, Geneva, IL (US); Michael Machowski, Camby, IN (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/559,479

(22) Filed: Nov. 14, 2006

(51) Int. Cl. B65G 13/00

(52) U.S. Cl. 193/37

(57) ABSTRACT

A flow track for a gravity conveyor system has a corrugated base panel with a series of alternating longitudinal peaks and valleys mounting a plurality of rotating assemblies. The rotating assemblies include rollers or skatewheels mounted for rotation on axles. The ends of the axles rest on the base panel peaks. The axle ends are secured by axle anchors formed on or in the peaks. The axle anchors include a spine that precludes axial movement of the axles.

### FIELD OF THE INVENTION

The present invention generally relates to gravity conveyors and is particularly concerned with an improved frame for a gravity flow track.

### BACKGROUND OF THE INVENTION

Gravity conveyors are well known in the materials handling industry. It is common for factories, warehouses, shipping facilities and the like to use gravity conveyors for transporting cartons, trays, pallets, totes or articles from one location to another. Gravity conveyors may also be used in a storage rack of a type comprising vertical posts, horizontally extending front and back beams connected to the posts, and a flow track, which is supported above the front and back beams. The flow track may be one of plural flow tracks on a given tier, which may be one of plural tiers. If each flow track is inclined, the storage rack is known as a carton flow storage rack or carton flow conveyor. Carton flow storage racks are used in order picking operations of distribution centers and manufacturing plants. In an order picking operation the inclined flow tracks are supplied on a restocking side of the rack with cartons containing products. The cartons flow by gravity from the restocking side of the rack to the opposite or picking side of the rack. There workers pick appropriate products and place them in shipping boxes or the like. Examples of prior art flow tracks are shown in U.S. Pat. Nos. RE. 38,517 and 6,951,441.

Flow racks of the type described have a frame which traditionally includes two or more longitudinal, parallel frame rails joined by fixed, transverse frame spacers. A plurality of rotating members, such as cylindrical rollers or skatewheels, are mounted for rotation on axles. The axles are attached to the frame rails at a longitudinal spacing appropriate for the type of article intended for transport. Where skatewheels are used as the rotating members they are laterally spaced on an axle by spacer tubes. The lateral spacing of the skatewheels is selected based on the characteristics of the articles to be transported.

While known gravity flow tracks perform their basic conveying function well enough, their frame construction is relatively inflexible. Fabricating conveyors of various widths and roller or skatewheel spacings is essentially a custom operation as the lengths of the frame spacers, axles, rollers or spacer tubes all vary. Even where these items are selected from standard sizes there is significant cost to the manufacturer to stock all the variously-sized components. What is needed is an improved frame construction that readily accommodates various flow track dimensions and uses standard rotating assemblies to do so.

### SUMMARY OF THE INVENTION

The present invention provides a flow track having a base panel that is a corrugated sheet having a series of longitudinal peaks and valleys. The corrugated sheet can be any panel consisting of parallel peaks and valleys but in a preferred embodiment it is a commercial B-deck panel. The width of the flow rack can be selected by cutting the B-panel to have the number of peaks and valleys that will produce the desired overall width.

A series of rotating assemblies are mounted on the base panel. The rotating assemblies each include an axle and at least one rotating member mounted for rotation on the axle. The rotating members can take any form appropriate for the articles to be transported, such as skatewheels or rollers. The ends of the axles rest atop the base panel peaks with the rotating members free to rotate in the valleys without interference.

The ends of the axles are secured to the supporting peaks by axle anchors. The anchors can be fixed to the top of each corrugated sheet peak. The axle anchor strip is preferably provided with equally spaced axle pockets sized to accept a rotating assembly axle. The multiplicity of pockets permits the longitudinal spacing of the rotating assemblies to be selected at the time of installation of the rotating members. In other words, the single base panel construction can accommodate a variety of spacings for the rotating members. The anchors preferably have two longitudinal rows of pockets formed by pairs of fingers upstanding from a sill. Intermediate the rows of fingers is a spine that prevents axial displacement of the axles.

### BRIEF DESCRIPTION OF THE DRAWINGS

FIG. 1 illustrates a side elevation view of a typical tier-type storage frame commonly found in warehouses and other material storage facilities with the flow track of this invention disposed across its span.

FIG. 2 depicts a front elevation view of the storage frame of FIG. 1.

FIG. 3 is a top plan view of the flow track of the present invention.

FIG. 4 is an end elevation view of the flow track of FIG. 3.

FIG. 5 is a view of a rotating assembly to be used with the flow track.

FIG. 6 is a top plan view of an axle anchor strip, on an enlarged scale.

FIG. 7 is a side elevation view of the axle anchor strip.

FIG. 8 is an end elevation view of the axle anchor strip.

### DETAILED DESCRIPTION OF THE INVENTION

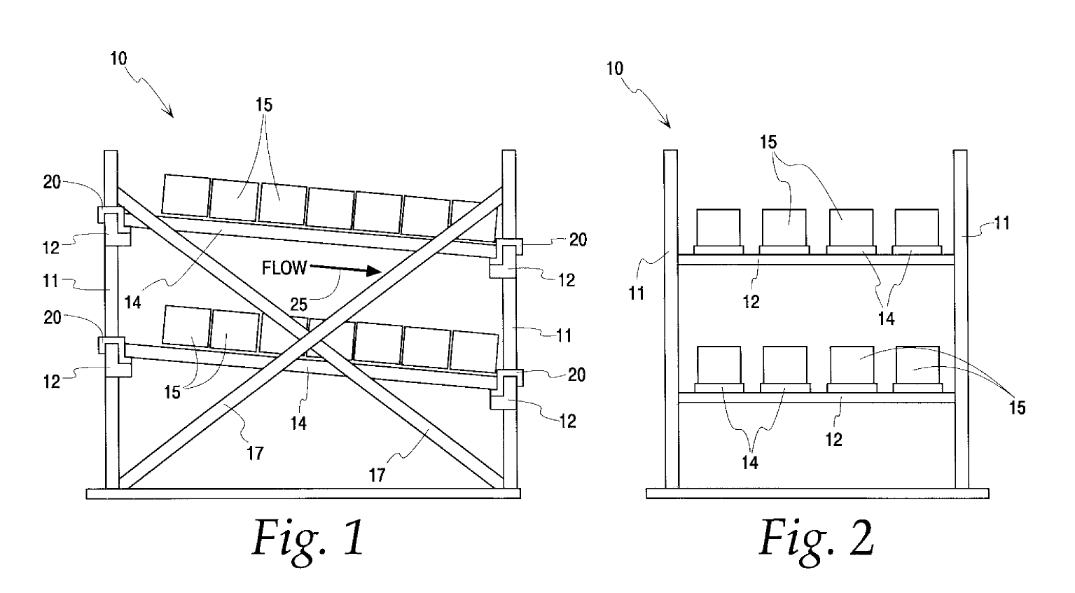

Referring to FIGS. 1 and 2, a typical tier-type storage frame 10 found in warehouses and other material storage facilities is shown in respective side and front views. This type of storage frame can accommodate the gravity conveyor of the present invention. The frame 10 comprises vertical support members 11 and horizontal end support beams 12, also known as form bars. Diagonal braces 17 (FIG. 1) can be used to enhance the rigidity of the storage frame 10. The flow tracks 14 of the present invention span the storage frame 10 between the end support beams 12. The flow tracks 14 are secured to the end support beams 12 by means of hangers 20. The flow tracks 14 are inclined from a higher, supply side on the left to a lower, picking side on the right, as viewed in FIG. 1. As a result cartons placed on the tracks will flow by gravity as shown by arrow 25. The end support beams 12 can support a plurality of flow tracks 14 on each tier, as illustrated in FIG. 2. Cartons 15 or other materials are carried by the flow tracks 14 in each tier.

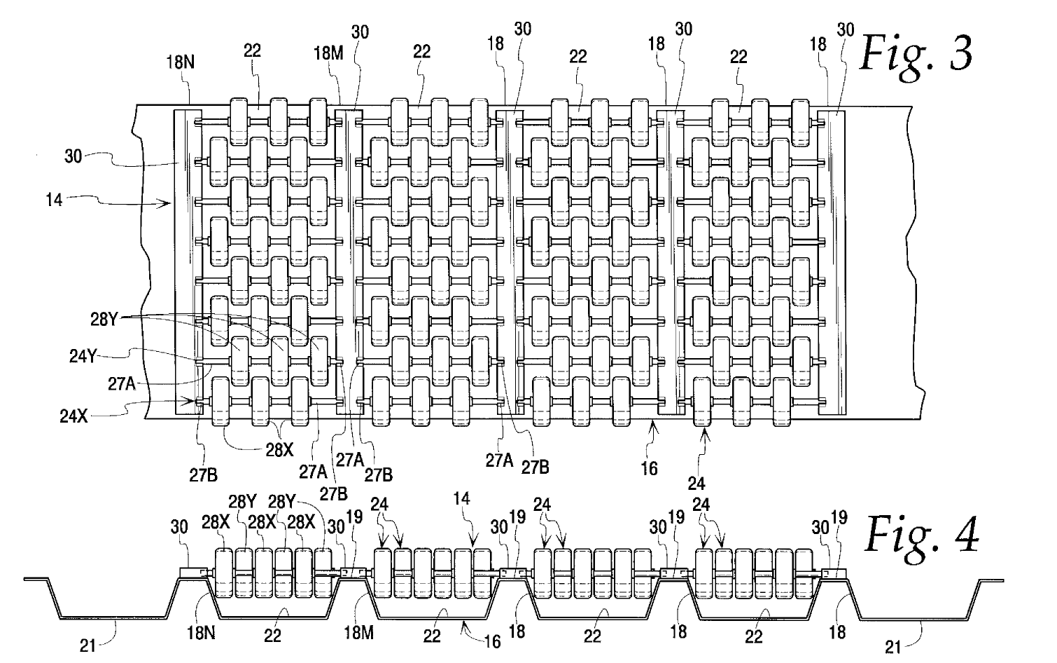

FIGS. 3 and 4 further illustrate the flow track 14. The flow track has a base panel 16 formed of commercial B-deck panel. The base panel has a corrugated configuration afforded by a plurality of peaks 18 and valleys 22. In the embodiment shown the valleys are flat, solid sheets. It will be understood that the valley sheets could be perforated to reduce weight and allow fluids to pass through the valleys. Also, while the valleys are shown having uniform widths, those widths could be variable. Likewise, the spacing of the peaks could be other than as shown. While the peaks 18 are shown as having a trapezoidal cross-section, it could be otherwise. It is preferred that the peaks have a flat top surface 19 for receiving the axle anchors, as will be explained below. It is also preferred that the peaks are relatively narrow compared to the valleys to provide the most space for the rotating assemblies, but the relative widths of the peaks and valleys could vary from that shown. For illustrative purposes only and not by way of limitation, the peak height could be about 1.5 inches while the center-to-center distance between adjacent peaks may be about 6 inches and the width of the peak top surface 19 is about 1 inch. The sides of the base panel may be provided with flanges 21. The flanges can be used for attachment of upstanding side rails or the like.

It can be seen that the overall width of the flow track can be readily altered with a standard B-deck panel by selecting the appropriate number of peaks 18 and valleys 22. The only limitation is that each valley that will receive rotating assemblies be bounded by a pair of peaks.

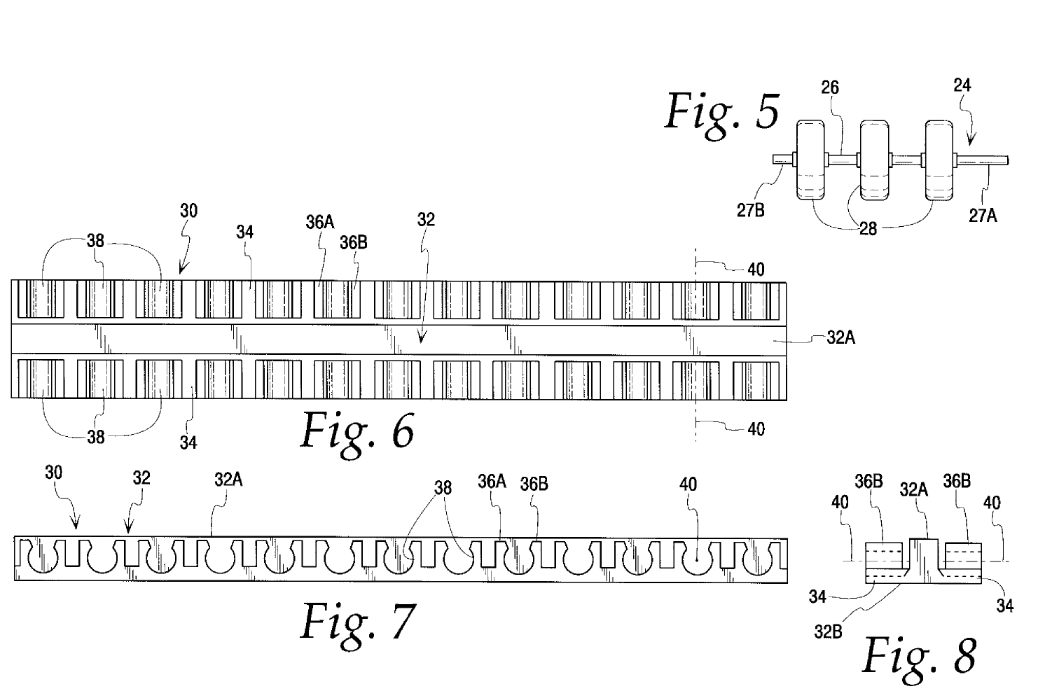

A rotating assembly 24 is shown separate from the base panel in FIG. 5. In the illustrated embodiment the rotating assembly has an axle 26 and three rotating members 28. The rotating members may be separated by spacer tubes (not shown). The rotating members are mounted remote from the ends of the axles. As shown here the rotating members are spaced from one another and offset from the center so there is a long end 27A and a short end 27B of the axle. The rotating members shown are skatewheels but it will understood that rollers or skatewheels of different widths could also be used. Each rotating member is mounted on a bearing that allows it to rotate freely on the stationary axle. Again by way of example only and using the dimensions of the base panel noted above, the axle may have a diameter of about 0.25 inches and a length of about 5.5 inches.

Turning now to FIGS. 6-8 an axle anchor 30 is shown. The axle anchor is an elongated plastic strip that is secured to the top surface 19 of the peaks 18. The anchor may be either glued to the peaks or secured by fasteners such as screws or the like. The anchor has a central, elongated spine 32 having top and bottom surface 32A, 32B. Side sills 34 extend from the bottom edge of the spine, flush with the bottom surface 34B. A plurality of pairs of upstanding fingers 36A, 36B are mounted on the sills 34. Each pair of fingers define a pocket 38 between them for receiving an axle. The fingers have tapered free ends for directing an axle into the pocket. The pockets 38 in turn define an axis 40 that generally aligns with the axis of an axle 26 mounted therein. It will also be noted that the heights of the spine and fingers, along with the location of the sills 24 are such that the axis 40 intersects with the spine 32. This means the spine serves as an end stop or abutment to prevent axial movement of the axles once they are placed in the pockets. The fingers, of course, prevent the axles from shifting in a direction parallel to the peak.

Returning to FIGS. 3 and 4, the assembly of the entire flow track will now be described. Once the base panel 16 is cut to the desired length and width the axle anchors 30 are fastened to the top surfaces 19 of the panel peaks. With the base panel thus prepared the rotating assemblies 24 can be inserted. To install a rotating assembly the rotating members 28 are placed partially into a valley between adjacent peaks 18 with the axle 26 spanning the width of the valley. The ends 27A, 27B of the axle are placed on top of the fingers 36A, 36B of laterally aligned pairs. The axle ends are then pressed down between the fingers to snap the axle ends into the pockets 38. The next longitudinally adjacent rotating 24 assembly is installed in alternating, interleaved fashion. That is, and with particular reference to the lower left corner of FIG. 3, the long end 27A of a first rotating assembly 24X is installed on the one peak 18M bounding a valley 22. The next rotating assembly 24Y has its long end 27A of the axle placed on the other peak 18N bounding that valley. Due to the offset location of the skatewheels 28 and their spacing, the skatewheels of longitudinally adjacent rotating assemblies are interleaved with one another. This allows for the tightest packing of skatewheels and provides the most continuous surface of rotating members. This is illustrated in FIGS. 3 and 4 where the skatewheels 28X of a first rotating assembly 24X are interleaved with skatewheels 28Y of a second, longitudinally spaced rotating assembly 24Y. This close spacing of the skatewheels is achieved using only a single configuration of a rotating assembly 24.

It can be seen how the flow rack of the present invention utilizes standard modules for the rotating assemblies and a standard base panel. With a minimum number of parts a flow rack of widely varying dimensions can be created. FIG. 3 shows a flow rack that is four valleys wide. Obviously it could be one, two, three or more than four valleys wide. The length is equally flexible as the axle anchors can be cut to whatever length needed to fit on the chosen length of the base panel. Further, this flexibility is achieved an minimum cost.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein. For example, instead of the axle anchors being a separate piece fixed to the peaks, the axle-receiving pockets could be formed on or in the peaks themselves. Also, instead of each skatewheel or roller having its own ball bearing, the axle anchors could incorporate journal bearings that allow the axle to rotate. that case the rotating member would not need its own bearing.

1. A flow track, comprising:
a corrugated base panel including at least two peaks and at least one valley intermediate the peaks;
a plurality of rotating assemblies each including an axle and at least one rotating member mounted for rotation on the axle; and
axle anchors on the peaks of the base panel, the axle anchors being engageable with an axle to secure said axle to the peak.

2. The flow track of claim 1 wherein the base panel further includes at least one lateral flange.

3. The flow track of claim 1 wherein each rotating assembly includes a plurality of rotating members.

4. The flow track of claim 1 wherein the rotating member is a skatewheel.

5. The flow track of claim 1 wherein the axle anchor includes at least one sill and at least one pair of upstanding fingers mounted on the sill, the fingers defining a pocket between them for receiving an axle.

6. The flow track of claim 5 wherein the fingers have tapered free ends for directing an axle into the pocket.

7. The flow track of claim 1 wherein the axle anchor includes a central, elongated spine, first and second sills attached to the spine on either side thereof and extending therefrom, and a plurality of pairs of upstanding fingers mounted on the sills, each pair of fingers defining a pocket between them for receiving an axle.

8. The flow track of claim 7 wherein the fingers have tapered free ends for directing an axle into the pocket.

9. The flow track of claim 7 further characterized in that the pockets define an axis and wherein the spine has top and bottom surfaces and the sill is attached to the spine below the top surface such that the axis of the pockets intersects the spine.

10. The flow track of claim 1 wherein the rotating members are skatewheels which are spaced apart along the axle and the longitudinal spacing of adjacent rotating assemblies is such that the skate wheels of said adjacent rotating assemblies are interleaved with one another.

11. A flow track, comprising:
a corrugated base panel including a plurality of peaks and valleys;
a plurality of rotating assemblies each including an axle having first and second ends and at least one rotating member mounted for rotation on the axle intermediate its ends, the first end of an axle being supported on one base panel peak and the second end of said axle being supported on a base panel peak adjacent to said one base panel peak such that said axle spans the valley intermediate said peaks and the rotating member of said rotating assembly is disposed at least partially in said valley.

12. The flow track of claim 11 wherein the base panel further includes at least one lateral flange.

13. The flow track of claim 11 wherein each rotating assembly includes a plurality of rotating members.

14. The flow track of claim 11 wherein the rotating member is a skatewheel.

15. The flow track of claim 11 further comprising at least one axle anchor on each peak, the axle anchor including at least one sill and at least one pair of upstanding fingers mounted on the sill, the fingers defining a pocket between them for receiving an axle.

16. The flow track of claim 15 wherein the fingers have tapered free ends for directing an axle into the pocket.

17. The flow track of claim 11 further comprising at least one axle anchor on each peak, the axle anchor including a central, elongated spine, first and second sills attached to the spine on either side thereof and extending therefrom, and a plurality of pairs of upstanding fingers mounted on the sills, each pair of fingers defining a pocket between them for receiving an axle.

18. The flow track of claim 17 wherein the fingers have tapered free ends for directing an axle into the pocket.

19. The flow track of claim 17 further characterized in that the pockets define an axis and wherein the spine has top and bottom surfaces and the sill is attached to the spine below the top surface such that the axis of the pockets intersects the spine.

20. The flow track of claim 11 wherein the rotating members are skatewheels which are spaced apart along the axle and the longitudinal spacing of adjacent rotating assemblies is such that the skate wheels of said adjacent rotating assemblies are interleaved with one another.

21. A method of manufacturing a flow track, comprising the steps of:
preparing a corrugated base panel including a plurality of peaks and valleys;
assembling a plurality of rotating assemblies each including an axle having first and second ends and at least one rotating member mounted for rotation on the axle intermediate its ends;
mounting the rotating assemblies on the base panel with the first end of an axle being supported on one base panel peak and the second end of said axle being supported on a base panel peak adjacent to said one base panel peak such that said axle spans the valley intermediate said peaks and the rotating members of said rotating assembly are disposed at least partially in each sheet valley.

22. The method of claim 21 further comprising the step of attaching axle anchors to the peaks of the base panel, and wherein the mounting step is characterized by inserting said first end of an axle into one axle anchor and by inserting said second end of said axle into an adjacent axle anchor.

23. The method of claim 22 wherein the mounting step in characterized by arranging the successive rotating assemblies such that their rotating members are interleaved with one another.
